(19) United States
(12) Patent Application Publication
(10) Pub. No.: US 2014/0197784 A1
(43) Pub. Date: Jul. 17, 2014

(54) WIRELESS SIDE CHARGING

(71) Applicant: Vishay Dale Electronics, Inc., Columbus, NE (US)

(72) Inventor: Randall B. Boldt, Omaha, NE (US)

(73) Assignee: Vishay Dale Electronics, Inc., Columbus, NE (US)

(21) Appl. No.: 14/152,246

(22) Filed: Jan. 10, 2014

Related U.S. Application Data
(60) Provisional application No. 61/751,562, filed on Jan. 11, 2013.

(51) Int. Cl. H02J 7/02

(52) U.S. Cl. CPC H02J 7/025
USPC 320/108

(57) ABSTRACT

Devices to be charged and wireless charging devices are disclosed. A DTBC includes a processing unit, a battery, an axially wound receiver coil and battery charging components. The battery powers the processing unit. The axially wound receiver coil has a first end and a second end located at opposite ends of a central axis of the axially wound receiver coil and receives electromagnetic flux via either one of the first end or the second end. The battery charging components are coupled between the battery and the axially wound receiver coil, convert the electromagnetic flux into direct current (DC) and apply the DC to charge the battery.

### CROSS REFERENCE TO RELATED APPLICATION(S)

This application claims the benefit of U.S. Provisional Application 61/751,562 filed Jan. 11, 2013, which is incorporated by reference as if fully set forth.

### FIELD OF INVENTION

The embodiments of the present invention described herein relate to wireless side charging of wireless devices.

### BACKGROUND

As the world becomes increasingly more wireless, many people are becoming increasingly more dependent on wireless devices, such as cellular telephones, laptops and tablet personal computers (PCs), for communication, work, appointment scheduling, entertainment, etc. As wireless devices are made to include more functionality, the drain on their batteries may also be greater. Accordingly, ease of battery charging for wireless devices may be an increasingly important feature for many people.

### SUMMARY

Devices to be charged are described herein. In one embodiment, a device to be charged (“DTBC”) includes a processing unit, a battery, an axially wound receiver coil and battery charging components. The battery is configured to power the processing unit. The axially wound receiver coil may include a first end and a second end located at opposite ends of a central axis of the axially wound receiver coil, and the axially wound receiver coil may be configured to receive electromagnetic flux via either one of the first end or the second end. The battery charging components may be coupled between the battery and the axially wound receiver coil. The battery charging components may be configured to convert the electromagnetic flux into direct current (DC) and apply the DC to charge the battery.

Wireless charging devices are also described herein. In one embodiment, a wireless charging device includes a casing comprising a front surface, a back surface and a side surface and a charging coil configured to emit an electromagnetic flux through the side surface of the casing to charge a battery disposed in an external device.

### BRIEF DESCRIPTION OF THE DRAWINGS

A more detailed understanding may be had from the following description, given by way of example in conjunction with the accompanying drawings, wherein:

FIG. 1A is a block diagram of an example DTBC and wireless charging device;

FIG. 1B is a diagram of an example DTBC showing an example placement of an axially wound receiver coil within a casing;

FIG. 1C is a diagram of an example wireless charging device showing an example placement of a axially wound charging coil within a casing;

FIGS. 2A, 2B and 2C are examples of different types of DTBCs;

FIGS. 3A, 3B, 3C, 3D and 3E are diagrams of example wireless charging devices showing different arrangements of different numbers of axially wound charging coils within different-shaped casings;

FIG. 4. is a diagram of an example axially wound charging coil;

FIG. 5 is a diagram of an example axially wound receiver coil;

FIG. 6 is a diagram showing emission and reception of electromagnetic flux from/by the axially wound charging coil of FIG. 4 and the axially wound receiver coil of FIG. 5; and

FIGS. 7A, 7B, 7C and 7D are diagrams of example wireless charging systems including at least one DTBC and at least one charging device.

### DETAILED DESCRIPTION OF THE DRAWINGS

Wired and wireless charging methods may be used to charge DTBCs. To perform wired charging of a DTBC, one end of a cord may be plugged into a connector in the DTBC. The other end of the cord may terminate in a connection component (e.g., a universal serial bus (USB) connector or an AC connector). If the cord terminates in an AC connector, the cord may be plugged directly into an AC outlet. If the cord terminates in another type of connector such as USB, the cord may be plugged into a computer or may require an additional piece of equipment (e.g., an adapter) to plug the cord into an AC outlet.

AC outlets in many houses and public buildings include two sockets. Accordingly, if a person has more than two DTBCs to charge (or needs to use one of the sockets to power a wired device such as a PC, monitor, television, radio, etc.), the person will need to find another outlet to use (or if he or she does not have another available outlet, wait until a first device is charged to charge the second device). This can be very frustrating, particularly when the person wishes to charge several DTBCs at once and does not want to search around for other outlets or plug the DTBCs in different rooms of his or her house (if other outlets are even available).

One solution to this issue may be for the person to invest in a charging station. A charging station is a multiple-DTBC charging unit that may be plugged into a single AC socket and may receive more than one DTBC for charging. However, in this scenario, the person would need to have individual cords for each device, which may be difficult to keep track of and carry around. Another solution may be for the person to invest in a wireless charging device, which may be plugged into a single socket and may wirelessly provide charge to multiple DTBCs.

One type of wireless multi-DTBC charger is a “mat” style charger. The mat is a flat unit that plugs into a single AC socket and provides wireless charging for DTBCs placed on top of it. To charge the DTBCs, a transmitter coil in the mat provides electromagnetic flux through the top surface of the mat, which may be received by one or more DTBCs placed on top of the mat.

Because DTBCs must be placed on top of the charging mat in order to receive the electromagnetic flux, there is limited space for DTBCs on the mat. So, for example, it may be difficult to charge a larger device, such as a tablet PC or a laptop, and it may be particularly difficult to charge such a device at the same time as another device, such as a cellular telephone. Additionally, once the DTBC is placed on top of the mat, the mat is partially or completely covered. Therefore, the branding value of the mat is greatly reduced.

Embodiments described herein include DTBCs and wireless chargers that may emit/receive electromagnetic flux in a horizontal direction (e.g., wireless side charging), thus allowing, for example, several DTBCs of all different sizes to be charged by a wireless charger at the same time without covering up any branding placed on the charger. An existing horizontal plane (such as a table) may be used to orient the DTBCs in the correct plane with the axially wound charging coils. Accordingly, multiple DTBCs may be arranged around a relatively small central charging station in a 360 degree fashion.

When referred to hereafter, the terminology “device to be charged” (“DTBC”) includes, but it not limited to, user equipment (UE), a mobile station, a fixed or mobile subscriber unit, a pager, a cellular telephone, a computer, or any other type of battery-powered device configured to receive a charge. Further, when referred to hereafter, the terminology “wireless charging device” includes, but it not limited to, a stand alone wireless charging device, a DTBC, or any other type of device that is configured to wirelessly supply a charge to at least one DTBC.

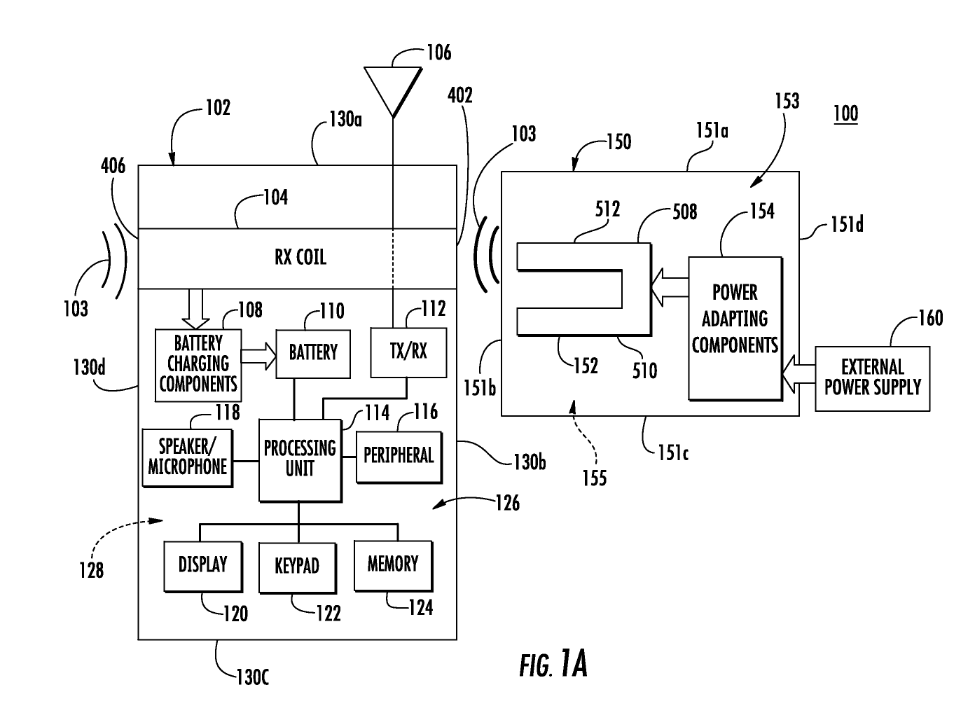

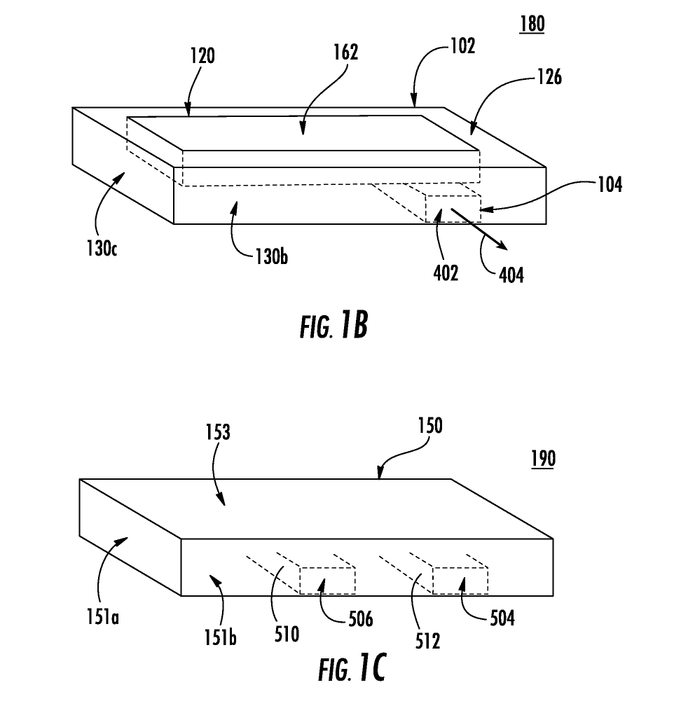

FIG. 1A is a block diagram 100 of an example DTBC 102 and wireless charging device 150. The illustrated DTBC 102 includes an axially wound receiver coil 104, battery charging components 108, an antenna 106 and a processing unit 114 coupled to a battery 110, a transceiver 112, one or more peripheral devices 116, a memory 124, a display 120, a keypad 122 and a speaker/microphone 118. The battery 110 may be configured to power the display 120 and the processing unit 114.

The battery charging components 108 may include, for example, an alternating current (AC) to direct current (DC) converter and a battery charger (not shown) and may be configured to convert electromagnetic flux 103 received from the wireless charging device 150 into DC (e.g., via the AC to DC converter) and apply the DC to charge the battery 110 (e.g., via the battery charger). The battery charging components 108 are electrically coupled between the battery 110 and the axially wound receiver coil 104.

The axially wound receiver coil 104, the battery charging components 108, the battery 110, the transceiver 112, the speaker/microphone 118, the processing unit 114, the one or more peripheral devices 116, the display 120, the keypad 122 and the memory 124 are housed in a casing that comprises a front surface 126, a back surface 128 and a side surface 130. In the illustrated example, the side surface 130 includes portions 130a, 130b, 130c and 130d. In an embodiment, several housings may be used. For example, a housing for the “power-related” components may be used to keep these components self-contained. This permits those components to be replaced when, for example, battery performance ultimately declines.

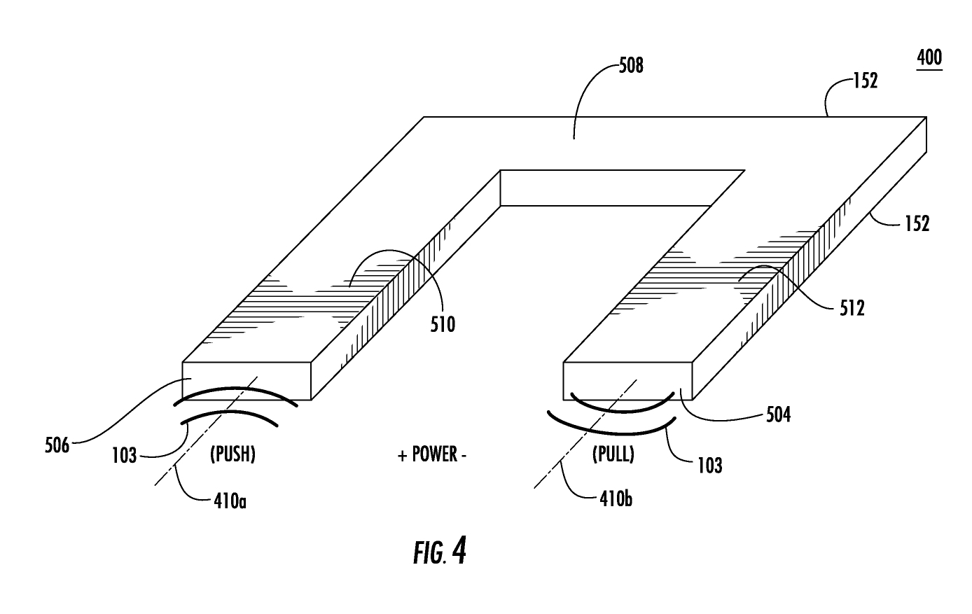

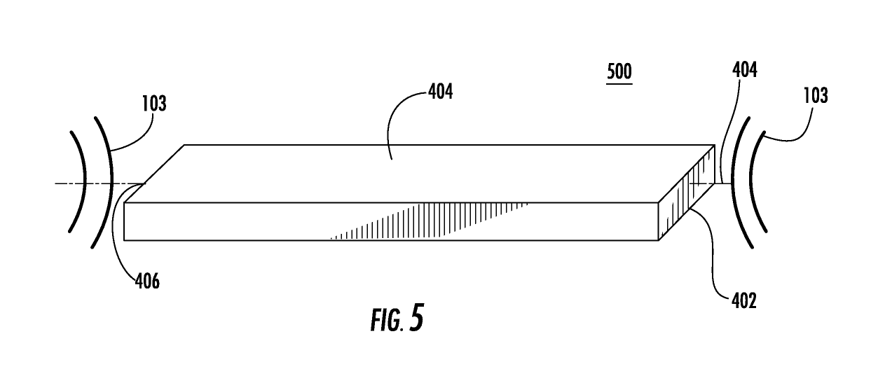

The illustrated wireless charging device 150 includes an axially wound charging coil 152 and power adapting components 154. The power adapting components may include, for example, one or more AC to DC converting components, DC to AC converting components and/or other electronic components that, either alone or in combination, are configured to receive an AC from an external power supply 160 (e.g., by plugging the wireless charging device 150 into a wall socket), adapt the AC from the external power supply 160 and apply it to the axially wound charging coil 152 such that the axially wound charging coil 152 emits the electromagnetic flux 103 (e.g., as described with respect to FIG. 4 below). Such power adapting components are known in the art and, therefore, are not described in detail herein.

In an embodiment, the axially wound charging coil 152 is a horseshoe-type charging coil that comprises a first leg 512, a second leg 510 and a connection portion 508 that connects the first leg 512 and the second leg 510. The axially wound charging coil 152 is configured to receive a current from the power adapting components 154 and provide the electromagnetic flux 103 through an end surface of one of the first leg 512 and the second leg 510 (in the illustrated example, the electromagnetic flux 103 is provided through the end surface of the first leg 512). While a horse-shoe type charging coil is described and illustrated throughout this description, any type of axially wound charging coil that receives a current and emits an electromagnetic flux via an end surface (i.e., a surface that is located at either end of a central axis of the coil) may be used consistent with the embodiments of wireless side charging described herein. For example, an axially wound transmitter coil may have a shape that includes more than two legs.

The axially wound charging coil 152 and the power adapting components 154 may be housed in a casing that comprises a top surface 153, a bottom surface 155 and a side surface 151. In the illustrated example, the side surface 151 includes portions 151a, 151b, 151c and 151d.

In the example illustrated in FIG. 1, the side surfaces 130b and 151b of the DTBC 102 and the wireless charging device 150 are disposed adjacent one another such that the axially wound receiver coil 104 may receive the electromagnetic flux 103 emitted from the first leg 512 of the horseshoe-type inductive transmitter coil 512 via a first end 402 for use in charging the battery 110. However, as illustrated, the axially wound receiver coil 104 is configured to receive electromagnetic flux 103 from either one of the first end 402 and the second end 406. Accordingly, in an embodiment, the side surface 130d of the DTBC 102 may be placed adjacent the side surface 151b of the wireless charging device 150 to receive the electromagnetic flux 103 to charge the battery 110.

FIG. 1B is a diagram 180 of an example DTBC 102 showing an example placement of the axially wound receiver coil 104 within the casing. In the illustrated example, the display 162 is disposed within the casing such that a surface 162 of the display 120 is exposed from the front surface 126 of the casing. Further, in the illustrated example, the axially wound receiver coil 104 is disposed within the casing such that a first end 402 of the axially wound receiver coil 104 is adjacent the side surface 130b of the casing.

In one embodiment, the positioning of the axially wound receiver coil 104 within the casing is such that the electromagnetic flux may be received by the axially wound receiver coil 104 through the side surface 103b of the casing. A second end of the axially wound inductive receiver coil 104 is not illustrated in FIG. 1B but is located at the opposite end of a central axis 404 of the axially wound receiver coil 104 from the first end 402 adjacent the portion 130d of the side surface 130. As described hereinbefore, the second end of the axially wound receiver coil is also configured to receive electromagnetic flux through the side surface 130 of the casing (e.g., through the portion 130d).

In the example of FIG. 1B, the axially wound receiver coil 104 is disposed within the casing such that it is below the display 120. However, one of ordinary skill in the art will recognize that other arrangements of the components of the DTBC 102 are within the scope of the embodiments described herein.

FIG. 1C is a diagram 190 of an example wireless charging device 150 showing an example placement of the axially wound charging coil within a casing. In the illustrated example, the axially wound charging coil is disposed within the casing such that edge surfaces 504 and 506 of the first leg 512 and the second leg 510 are adjacent the side surface 151 of the casing. In an embodiment, one of the edge surfaces 504 and 506 of the first leg 512 and the second leg 510 may emit the electromagnetic flux through the side surface 151 of the casing to charge a battery disposed in an external device (e.g., the DTBC 102). In the illustrated example, the edge surfaces 504 and 506 are disposed adjacent the portion 151b of the side surface 151. However, one or more axially wound charging coils may be disposed within the casing such that edge surfaces 504 and 506 of the first leg 512 and the second leg 510 of the one or more axially wound charging coils are disposed adjacent one or more of the surfaces 151a, 151b, 151c and 151d of the casing of the wireless charging device 150.

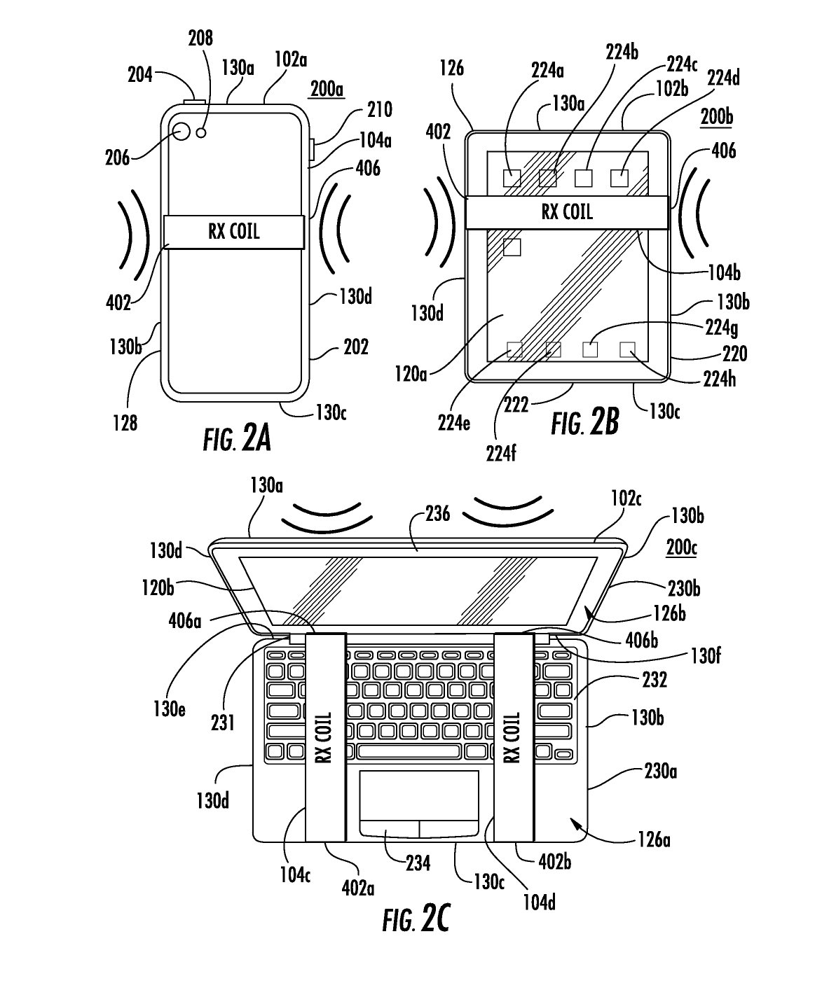

FIGS. 2A, 2B and 2C are examples of different types of DTBCs 102a, 102b and 102c.

In FIG. 2A, the illustrated DTBC 102a is a cellular telephone 200a. In the illustrated example, the cellular telephone 200a includes a casing 202 that includes the back surface 128, the front surface 126 opposite the back surface (not shown) and the side surface 130 with portions 130a, 130b, 130c and 130d. The illustrated cellular telephone 200a also includes a camera lens 206, a camera flash 208, an on/off button 204, a volume control section 210 and an axially wound inductive receiver coil 104a. The illustrated axially wound receiver coil 104a is disposed within the casing such that the first end 402 and the second end 406 are adjacent the portions 130b and 130d, respectively, of the side surface 130 of the casing 202 such that the electromagnetic flux may be received by the axially wound inductive receiver coil 104a through the side surface 130 of the casing 202. In an alternative embodiment (not shown), the axially wound receiver coil 104a may be oriented within the casing 202 such that the end 406 is adjacent the surface 130a and the end 406 is adjacent the surface 130c. As with the embodiments illustrated in FIGS. 1A and 1B, the axially wound receiver coil 104a is configured to receive electromagnetic flux via either one of the first end 402 and the second end 406.

In FIG. 2B, the illustrated DTBC 102b is a tablet PC 200b. In the illustrated example, the tablet PC 200b includes a casing 220 that includes the front surface 126, the back surface 128 opposite the front surface (not shown) and the side surface 130 with portions 130a, 130b, 130c and 130d. The illustrated tablet PC 200b also includes a display 120a, a multi-function button 222 (e.g., used to return to a main screen, turn on the display 120a, etc.), a plurality of icons 224a, 224b, 224c, 224d, 224e, 224f, 224g and 224h, and an axially wound receiver coil 104b. The illustrated axially wound inductive receiver coil 104b is disposed within the casing 220 such that the first end 402 and the second end 406 are adjacent the portions 130d and 130b, respectively, of the side surface 130 of the casing 220 such that the electromagnetic flux may be received by the axially wound receiver coil 104b through the side surface 130 of the casing 220. In an alternative embodiment (not shown), the axially wound receiver coil 104b may be oriented within the casing such that the end 406 is adjacent the surface 130a and the end 402 is adjacent the surface 130c. As with the embodiments illustrated in FIGS. 1A, 1B, and 2A, the axially wound receiver coil 104b is configured to receive electromagnetic flux via either one of the first end 402 and the second end 406.

In FIG. 2C, the illustrated DTBC 102c is a laptop 200c. In the illustrated example, the laptop 200c includes a casing 230 that is a clamshell type casing formed from a first portion 230a and a second portion 230b connected via a hinge 231. The casing illustrated casing 230 has a side surface 130 that includes portions 130a, 130b, 130c, 130d, 130e and 130f. The first portion 230a of the casing 230 includes a display 120b having a surface exposed from a front surface 126b of the casing 230 and a camera lens 236. The second portion 230b of the casing 230 includes a keypad 232 having a surface exposed from a front surface 126a of the casing 230, a mouse pad 234, and at least one axially wound receiver coil (two axially wound inductor receiver coils 140c and 140d are illustrated in FIG. 2C). The illustrated axially wound receiver coils 104c and 104d are disposed within the casing 230 such that the first ends 402a and 402b and the second ends 406a and 406b are adjacent the portions 130c and 130e, respectively, of the side surface 130 of the casing 230 such that the electromagnetic flux may be received by the axially wound receiver coils 104c and 104d through either of the side surfaces 130c and 130e of the casing 230. While two axially wound receiver coils 104c and 104d are illustrated in FIG. 2C, the laptop 200c may only include one receiver coil 104c or may include any number of receiver coils 104c. As with the embodiments illustrated in FIGS. 1A, 1B, 2A and 2B, the axially wound receiver coils 104c and 104d are configured to receive electromagnetic flux via either of the first ends 402a and 402b and the second ends 406a and 406b.

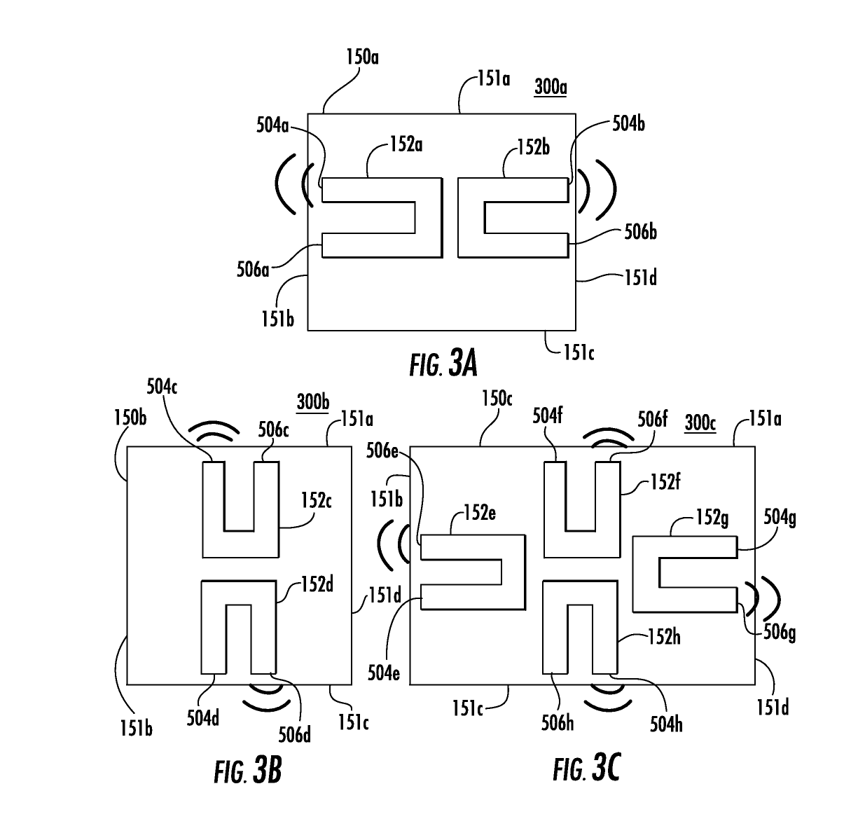

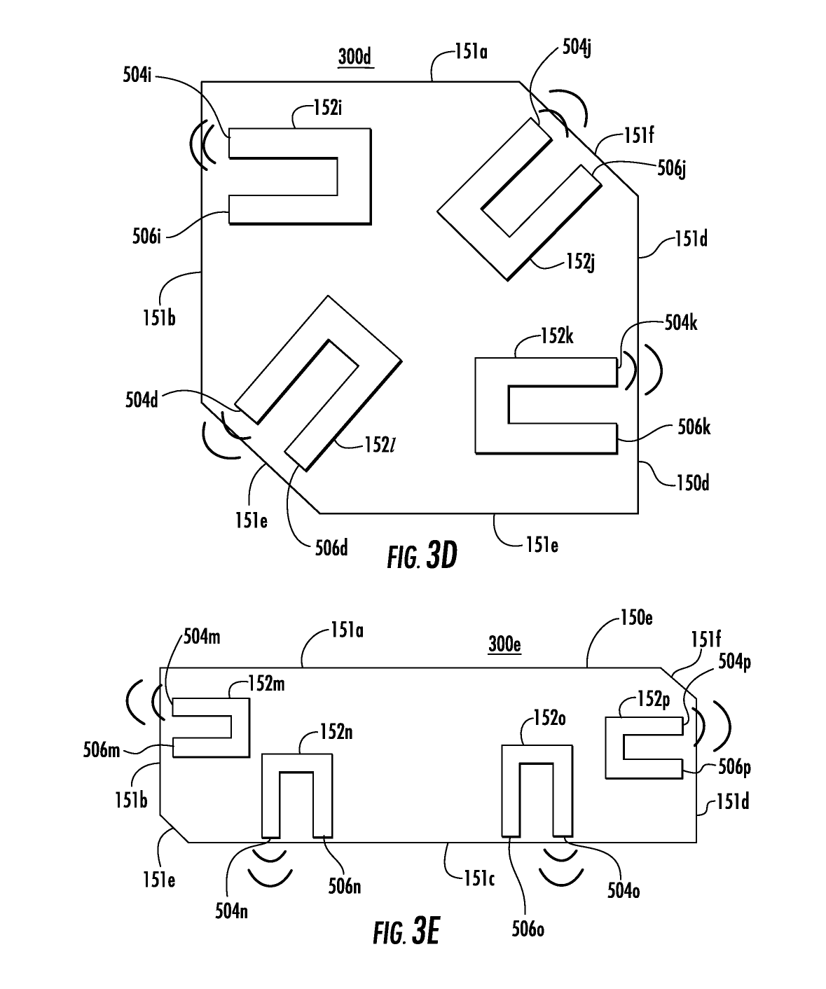

FIGS. 3A, 3B, 3C, 3D and 3E are diagrams 300a, 300b, 300c, 300d and 300e of example wireless charging devices showing different arrangements of different numbers of axially wound charging coils within different-shaped casings. While specific arrangements and specific numbers of axially wound charging coils are illustrated in the various embodiments illustrated in FIGS. 3A, 3B, 3C, 3D and 3E, any number of different arrangements and numbers of axially wound charging coils may be included in a wireless charging device in accordance with the embodiments described herein.

The wireless charging device 150a illustrated in FIG. 3A includes two axially wound charging coils 152a and 152b. The illustrated wireless charging device 150a includes a polygonal-shaped casing that has a side surface 151 that includes four portions 151a, 151b, 151c and 151d (e.g., rectangular-shaped). In the illustrated example, the edges 504a and 506a of the axially wound charging coil 152a are disposed adjacent the portion 151b of the side surface 151, and the edges 504b and 506b of the axially wound charging coil 152b are disposed adjacent the portion 151d of the side surface 151. Thus, the axially wound charging coil 152a is configured to emit the electromagnetic flux via one of the first and second edges 504a and 506a through the portion 151b of the side surface 151 of the casing, and the axially wound charging coil 152b is configured to emit the electromagnetic flux via one of the first and second edges 504b and 506b through the portion 151d of the side surface 151 of the casing.

The wireless charging device 150b illustrated in FIG. 3B includes two axially wound charging coils 152c and 152d. The illustrated wireless charging device 150b includes a polygonal-shaped casing that has a side surface 151 that includes four portions 151a, 151b, 151c and 151d (e.g., rectangular-shaped). In the illustrated example, the edges 504c and 506c of the axially wound charging coil 152c are disposed adjacent the portion 151a of the side surface 151, and the edges 504d and 506d of the axially wound charging coil 152d are disposed adjacent the portion 151c of the side surface 151. Thus, the axially wound charging coil 152c is configured to emit the electromagnetic flux via one of the first and second edges 504c and 506c through the portion 151a of the side surface 151 of the casing, and the axially wound charging coil 152d is configured to emit the electromagnetic flux via one of the first and second edges 504d and 506d through the portion 151c of the side surface 151 of the casing.

The wireless charging device 150c illustrated in FIG. 3C includes four axially wound charging coils 152e, 152f, 152g, and 152h. The illustrated wireless charging device 150c includes a polygonal-shaped casing that has a side surface 151 that includes four portions 151a, 151b, 151c and 151d (e.g., rectangular-shaped). In the illustrated example, the edges 504e and 506e of the axially wound charging coil 152e are disposed adjacent the portion 151b of the side surface 151, the edges 504f and 506f of the axially wound charging coil 152f are disposed adjacent the portion 151a of the side surface 151, the edges 504g and 506g of the axially wound charging coil 152g are disposed adjacent the portion 151d of the side surface 151, and the edges 504h and 506h of the axially wound charging coil 152h are disposed adjacent the portion 151c of the side surface 151. Thus, the axially wound charging coil 152e is configured to emit the electromagnetic flux via one of the first and second edges 504e and 506e through the portion 151b of the side surface 151 of the casing, the axially wound charging coil 152f is configured to emit the electromagnetic flux via one of the first and second edges 504f and 506f through the portion 151a of the side surface 151 of the casing, the axially wound charging coil 152g is configured to emit the electromagnetic flux via one of the first and second edges 504g and 506g through the portion 151d of the side surface 151, and the axially wound charging coil 152h is configured to emit the electromagnetic flux via one of the first and second edges 504h and 506h through the portion 151c of the side surface 151 of the casing.

The wireless charging device 150d illustrated in FIG. 3D includes four axially wound charging coils 152i, 152j, 152k, and 152l. The illustrated wireless charging device 150d includes a polygonal-shaped casing that has a side surface 151 that includes six portions 151a, 151b, 151c, 151d, 151e and 151f. In the illustrated example, the edges 504i and 506i of the axially wound charging coil 152i are disposed adjacent the portion 151b of the side surface 151, the edges 504j and 506j of the axially wound charging coil 152j are disposed adjacent the portion 151f of the side surface 151, the edges 504k and 506k of the axially wound charging coil 152k are disposed adjacent the portion 151d of the side surface 151, and the edges 504l and 506l of the axially wound charging coil 152l are disposed adjacent the portion 151e of the side surface 151. Thus, the axially wound charging coil 152i is configured to emit the electromagnetic flux via one of the first and second edges 504i and 506i through the portion 151b of the side surface 151 of the casing, the axially wound charging coil 152j is configured to emit the electromagnetic flux via one of the first and second edges 504j and 506j through the portion 151f of the side surface 151 of the casing, the axially wound charging coil 152k is configured to emit the electromagnetic flux via one of the first and second edges 504k and 506k through the portion 151d of the side surface 151, and the axially wound charging coil 152l is configured to emit the electromagnetic flux via one of the first and second edges 504l and 506l through the portion 151e of the side surface 151 of the casing.

The wireless charging device 150e illustrated in FIG. 3E includes four axially wound charging coils 152m, 152n, 152o, and 152p. The illustrated wireless charging device 150e includes a polygonal-shaped casing that has a side surface 151 that includes six portions 151a, 151b, 151c, 151d, 151e and 151f. In the illustrated example, the edges 504m and 506m of the axially wound charging coil 152m are disposed adjacent the portion 151b of the side surface 151, the edges 504n and 506n of the axially wound charging coil 152n and the edges 504o and 506o of the axially wound charging coil 152o are disposed adjacent the portion 151c of the side surface 151, and the edges 504p and 506p of the axially wound charging coil 152p are disposed adjacent the portion 151d of the side surface 151. Thus, the axially wound charging coil 152m is configured to emit the electromagnetic flux via one of the first and second edges 504m and 506m through the portion 151b of the side surface 151 of the casing, the axially wound charging coil 152n is configured to emit the electromagnetic flux via one of the first and second edges 504n and 506n through the portion 151c of the side surface 151 of the casing, the axially wound charging coil 152o is configured to emit the electromagnetic flux via one of the first and second edges 504o and 506o through the portion 151c of the side surface 151 of the casing, and the axially wound charging coil 152p is configured to emit the electromagnetic flux via one of the first and second edges 504p and 506p through the portion 151d of the side surface 151 of the casing.

FIG. 4 is a diagram 400 of an example horseshoe-type charging coil 152 that may be used as the axially wound charging coil 152. The illustrated horseshoe-type charging coil 152 has a first leg 510, a second leg 512 and a connecting portion 508 that connects the first leg 510 and the second leg 512. As illustrated, the horseshoe-type charging coil 152 is configured to emit the electromagnetic flux 103 alternatively via the end surface 506 of the first leg 510 and the end surface 504 of the second leg 512. The end surfaces 504 and 506 are located at an end of their respective central axes 410b and 410a (which are extended out via dashed line in FIG. 4 for purposes of illustration). In the illustrated example, the horseshoe-type charging coil 152 may be hooked up to other electronic components within a wireless charging device so as to create an alternating magnetic field within the coil 152 that enables the electromagnetic flux 103 to be emitted from either end surface 504 or 506. In embodiments where axially wound charging coils are used that are not of a horse-shoe type, a similar effect may be created such that the electromagnetic flux 103 is emitted via one or more end surfaces that are located at an end of their respective central axes similar to the way the horseshoe-type coil emits electromagnetic flux 103 via the end surfaces 504 and 506 that are located at an end of the respective central axis 410b and 410a in FIG. 4.

FIG. 5 is a diagram 500 of an example axially wound receiver coil 104. The illustrated axially wound receiver coil 104 is a gumstick type receiver coil, which has a first end 402 and a second end 406 located at opposite ends of the central axis 404 of the axially wound receiver coil 104. As illustrated, the axially wound receiver coil 104 is configured to receive the electromagnetic flux 103 via either one of the first end 402 and the second end 406. For example, the axially wound receiver coil 104 may be hooked up within a wireless charging device so as to create an alternating magnetic filed within the axially wound receiver coil 104 such that magnetic flux may be received via either end 402 or 406. While a gumstick type receiver coil is illustrated in FIG. 5, a DTBC may include one or more of any type of axially wound receiver coil that enables the DTBC to receive magnetic flux via at least two portions of the side edge 130.

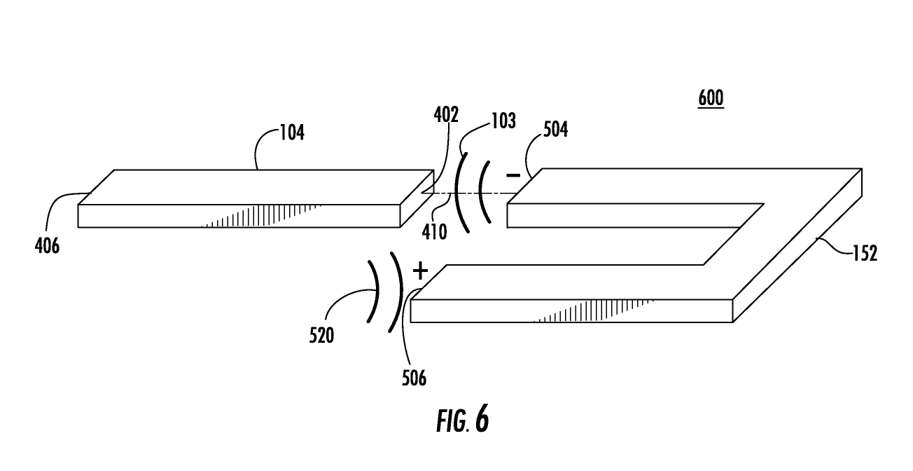

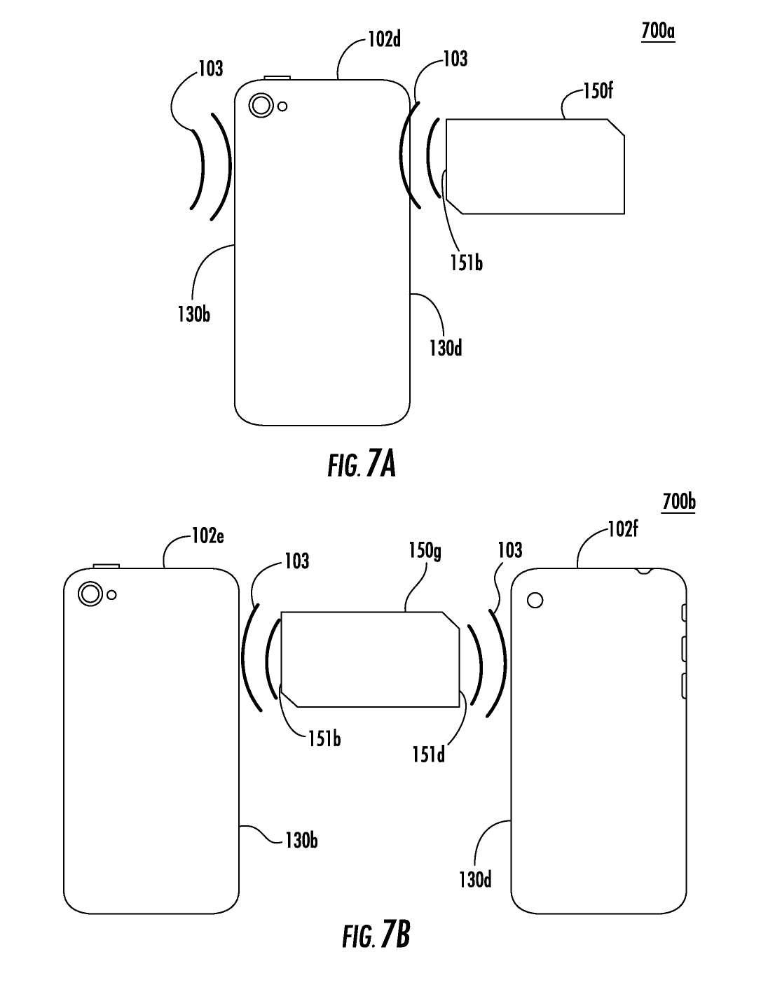

FIG. 6 is a diagram showing emission and reception of electromagnetic flux from/by the horseshoe-type transmitter coil 152 of FIG. 5 and the axially wound inductive receiver coil 104 of FIG. 4. In the illustrated example, the horseshoe-type transmitter coil 152 is hooked up to other electronic components within a wireless charging device so as to create an alternating electromagnetic field that enables the electromagnetic flux 103 to be emitted from the horseshoe-type transmitter coil 152 through both of its ends 504 and 506. The emitted electromagnetic flux 103 is received by the axially wound receiver coil 104 via the end 402. The axially wound receiver coil 104 is also configured to receive electromagnetic flux 103 via the end 406.

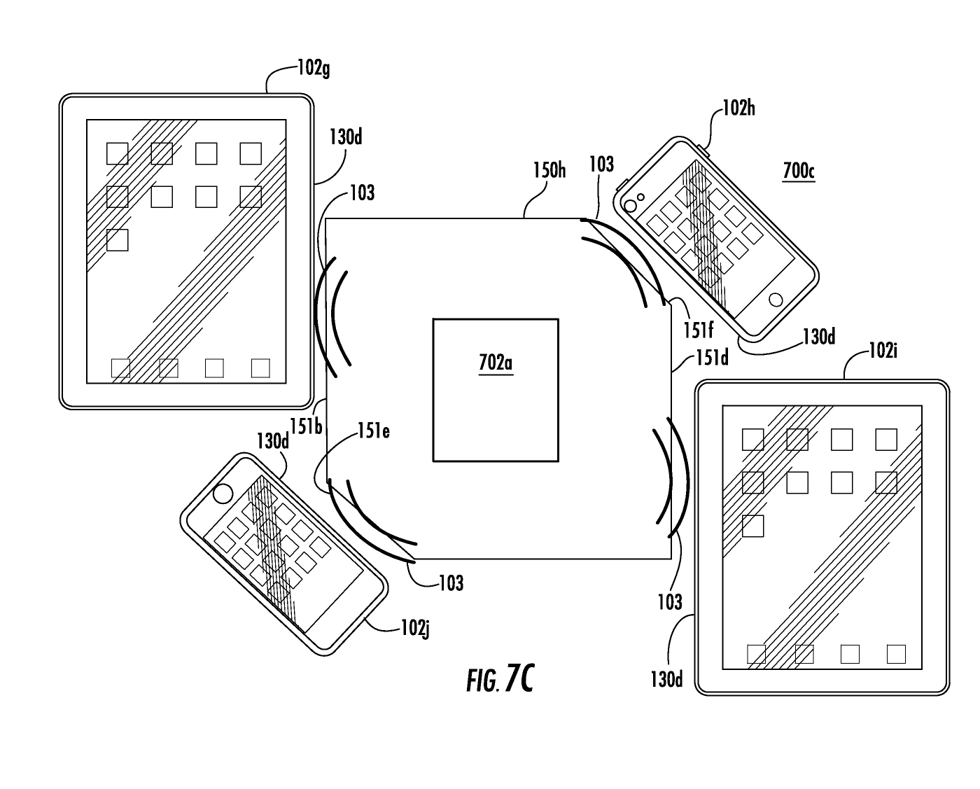

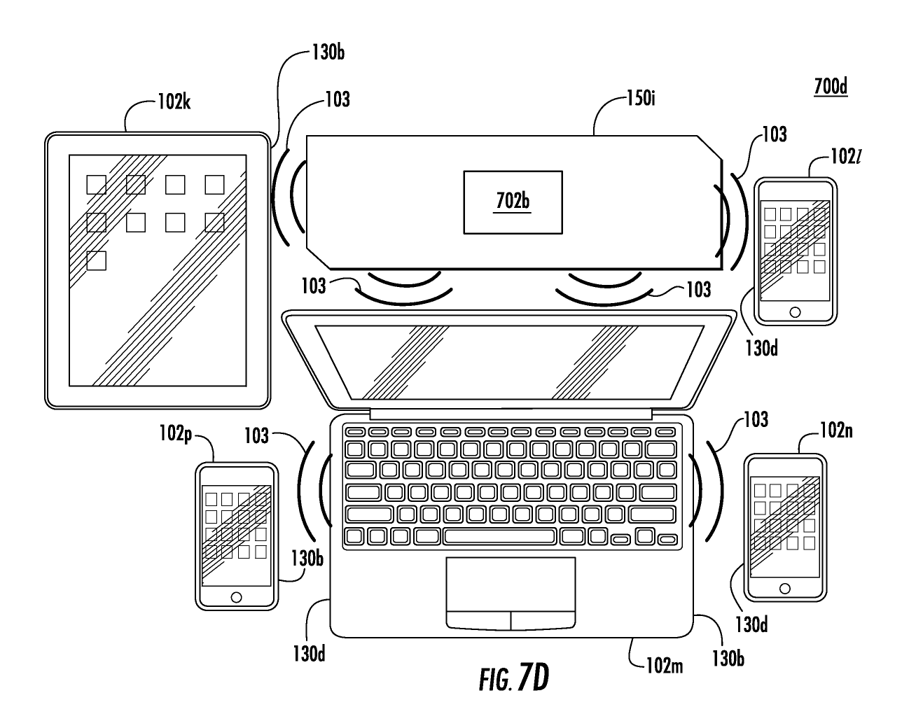

FIGS. 7A, 7B, 7C and 7D are diagrams of example wireless charging systems including at least one DTBC 102 and a charging device 150. The example systems illustrated in FIGS. 7A, 7B, 7C and 7D show examples of different DTBCs 102 that may be charged at the same time using a single wireless charging device 150 and different ways in which the various DTBCs 102 may be placed with respect to the wireless charging device 150 in order to receive a charge horizontally.

In FIG. 7A, the illustrated wireless charging system 700a includes a cellular telephone 102d and a wireless charging device 150f placed so that the portion 130d of the side surface 130 of the cellular telephone 102d is adjacent the portion 151b of the side surface 151 of the wireless charging device 150f. The wireless charging device 150f may emit electromagnetic flux 103, which may be received by the cellular telephone 102d via the portion 130d of the side surface 130. The cellular telephone 102d is also configured to receive electromagnetic flux 103 via the portion 130b of the side surface 130.

In FIG. 7B, the illustrated wireless charging system 700b includes two cellular telephones 102e and 102f and a wireless charging device 150g placed so that the portion 130b of the side surface 130 of the cellular telephone 102e is adjacent the portion 151b of the side surface 151 of the wireless charging device 150g and the portion 130d of the side surface 130 of the cellular telephone 102f is adjacent the portion 151d of the side surface 151 of the wireless charging device 250g. The wireless charging device 150g may emit electromagnetic flux 103, which may be received by both of the cellular telephones 102e and 102f via the portion 130b of the side surface 130 of the cellular telephone 102e and via the portion 130d of the side surface 130 of the cellular telephone 102f. In the illustrated example, a user may charge two cellular telephones at the same time using a single wireless charging device.

In FIG. 7C, the illustrated wireless charging system 700c includes two cellular telephones 102h and 102j, two tablet PCs 102g and 102i, and a wireless charging device 150h placed so that the portion 130d of the side surface 130 of the cellular telephone 102j is adjacent the portion 151e of the side surface 151 of the wireless charging device 150h, the portion 130d of the cellular telephone 102h is adjacent the portion 151f of the side surface 151 of the wireless charging device 150h, the portion 130d of the side surface 130 of the tablet PC 102g is adjacent the portion 151b of the side surface 151 wireless charging device 150h, and the portion 130d of the side surface 130 of the tablet PC 102i is adjacent the portion 151d of the side surface 151 of the wireless charging device 150h. The wireless charging device 150h may emit electromagnetic flux 103, which may be received by both of the cellular telephones 102h and 102j and both of the tablet PCs 102g and 102i via the portions 130d of their side edges 130. In the illustrated example, a user may charge two cell phones and two tablet PCs (i.e., four DTBCs) at the same time using a single wireless charging device. The illustrated wireless charging device 150h also includes a region 702a for placement of branding, which is not covered by any of the DTBCs during charging.

In FIG. 7D, the illustrated wireless charging system 700d includes three cellular telephones 102l, 102n and 102p, a tablet PC 102k, a laptop computer 102m and a wireless charging device 150i placed so that the portion 130d of the side surface 130 of the cellular telephone 102l is adjacent the portion 151d of the side surface 151 of the wireless charging device 150i, the portion 130b of the side surface 130 tablet PC 102k is adjacent the portion 151b of the side surface 151 of the wireless charging device 150i, and the portion 130e of the side surface 130 of the tablet PC 102m is adjacent the portion 151c of the side surface 151 of the wireless charging device 150i. The wireless charging device 150i may emit electromagnetic flux 103, which may be received by the cellular telephone 102l via the portion 130d of its side surface 130, by the tablet PC 102k via the portion 130b of its side surface 130, and by the laptop 102m via the portion 130e of its side surface 130. In the illustrated example, a user may charge a cell phone, a tablet PC, and a laptop (three DTBCs) at the same time using a single wireless charging device. The illustrated wireless charging device 150i also includes a region 702b for placement of branding, which is not covered by any of the devices during charging.

FIG. 7D also illustrates an embodiment where a DTBC is also configured as a wireless charging device (i.e., it includes the elements for both the DTBC 102 and the wireless charging device 150 illustrated in FIG. 1A). Thus, in the example illustrated in FIG. 7D, the laptop 102m may receive a charge from the wireless charging device as illustrated and described above and may also charge DTBCs placed adjacent its side surface 130. In the illustrated example, two additional cellular telephones 102p and 102n are configured to be charged by the laptop 102m. Thus, in the example system illustrated in FIG. 7D, five DTBCs may be charged at the same time. While the illustrated example specifically shows a laptop that is configured as a wireless charging device, any DTBC may be configured as a wireless charging device (e.g., a notebook PC, a cellular telephone, etc.).

Although the features and elements of the present invention are described in the example embodiments in particular combinations, each feature may be used alone without the other features and elements of the example embodiments or in various combinations with or without other features and elements of the present invention.

What is claimed is:

1. A device to be charged (DTBC) comprising:
a processing unit;
a battery configured to power the processing unit;
an axially wound receiver coil comprising a first end and a second end located at opposite ends of a central axis of the axially wound receiver coil, the axially wound receiver coil being configured to receive electromagnetic flux via either one of the first end or the second end; and
battery charging components coupled between the battery and the axially wound receiver coil, the battery charging components being configured to convert the electromagnetic flux into direct current (DC) and apply the DC to charge the battery.

2. The device of claim 1, further comprising a casing that houses the processing unit, the battery and the battery charging components, the casing comprising a front surface, a back surface and a side surface, wherein the axially wound receiver coil is disposed within the casing such that the electromagnetic flux is received by the axially wound receiver coil through the side surface of the casing.

3. The device of claim 2, wherein the axially wound receiver coil is disposed within the casing such that the first end and the second end of the axially wound receiver coil are adjacent the side surface of the casing.

4. The device of claim 1, wherein the axially wound receiver coil is a gumstick type receiver coil.

5. The device of claim 1, wherein the battery charging components comprise:
an alternating current (AC) to DC converter configured to receive the electromagnetic flux from the axially wound inductive receiver coil and to provide a DC; and
a battery charger configured to apply the DC to charge the battery.

6. The device of claim 1, wherein the device is one of a cellular telephone, a notebook personal computer (PC) and a laptop computer.

7. A wireless charging device comprising:
a casing comprising a front surface, a back surface and a side surface; and
a charging coil configured to emit an electromagnetic flux through the side surface of the casing to charge a battery disposed in an external device.

8. The wireless charging device of claim 7, wherein the charging coil is an axially wound charging coil comprising at least one end surface located at an end of a central axis, the charging coil being configured to emit the electromagnetic flux via the at least one end surface through the side surface of the casing to charge the battery disposed in the external device.

9. The wireless charging device of claim 8, wherein the at least one end surface is disposed adjacent the side surface of the casing.

10. The wireless charging device of claim 8, wherein the axially wound charging coil is a horseshoe-type charging coil comprising at least two legs and a connecting portion that connects each of the at least two legs, the horseshoe-type charging coil being configured to provide the electromagnetic flux via an end surface of at least one of the at least two legs and through the side surface of the casing to charge the battery disposed in the external device.

11. The wireless charging device of claim 8, wherein the wireless charging device comprises a plurality of axially wound charging coils.

12. The wireless charging device of claim 11, wherein:
the casing is polygonal-shaped such that the side surface has at least four portions, and
the plurality of axially wound charging coils are disposed within the casing such that the at least one end surface of each of the plurality of axially wound charging coils is adjacent one of the at least four portions of the side surface.

13. The wireless charging device of claim 11, wherein the plurality of axially wound charging coils are disposed within the casing such that the at least one end surface of each of the plurality of axially wound charging coils is adjacent a different one of the at least four portions of the side surface.

14. The wireless charging device of claim 11, wherein the plurality of axially wound charging coils are disposed within the casing such that the at least one end surface of at least two of the plurality of axially wound charging coils is adjacent the same one of the at least four portions of the side surface.

15. The wireless charging device of claim 7, further comprising:
an axially wound receiver coil comprising a first end and a second end located at opposite ends of a central axis of the axially wound receiver coil, the axially wound receiver coil being configured to receive electromagnetic flux via either one of the first end or the second end; and
battery charging components coupled between the battery and the axially wound receiver coil, the battery charging components being configured to convert the electromagnetic flux into direct current (DC) and apply the DC to charge the battery.

16. The wireless charging device of claim 15, wherein the wireless charging device is one of a cellular telephone, a notebook personal computer (PC) and a laptop computer.
